(19) United States
(12) Patent Application Publication
(10) Pub. No.: US 2006/0168079 A1
(43) Pub. Date: Jul. 27, 2006

(54) SYSTEM AND METHOD FOR AUTOMATICALLY CONNECTING A CLIENT COMPUTER TO A SERVER

(76) Inventors: Cheng-Yin Shen, Shenzhen (CN); Tzu-Chiang Peng, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,675

(22) Filed: Oct. 26, 2005

(30) Foreign Application Priority Data
Dec. 24, 2004 (TW) 093140417

(51) Int. Cl. G06F 15/16

(52) U.S. Cl. 709/207

(57) ABSTRACT

A method for automatically connecting a client to a server includes the steps of: sending a request to the server to reboot the server through a communication network; setting a wait time for the client computer; displaying the wait time on the client computer; counting down the wait time once each second; determining whether the server has accomplished rebooting according to the wait time; and automatically connecting the client computer to the server, if the server has accomplished rebooting. A related system is also disclosed.

### FIELD OF THE INVENTION

The present invention relates to systems and methods for managing an application of a client-server environment, and more particularly to a system and method for automatically connecting a client to a server in the client-server environment.

### DESCRIPTION OF RELATED ART

A client-server (C/S) environment implies that an application is being jointly accomplished by two or more interdependent pieces of equipment, including software, hardware and interface. Generally, multiple clients connected to a server via an intranet which is any network (i.e. LAN or WAN) that supports not only internet applications, such as hypertext transfer protocol (HTTP), but also other applications, such as file transfer protocol (FTP). The client requests information and the server responses the information to the client immediately, with each one assigned the portion of a job which is suitable to its capabilities. The client-server can be achieved in a local area network of personal computers and servers or by means of a link between a user system and a large storage system (i.e. a file server). Typically, the client-server environment implies a many to one design, whereby multiple clients can make simultaneous requests of the server, allowing for the server information sharing between the clients.

Occasionally, the clients disconnect to the server because of network resource. In order to communicate with the server, the clients may repeatedly request to reconnect the server. For example, a client may typically lose touch with the file server when the client requests a command of rebooting the file server. Although repeatedly requesting to the file server, the client may also disconnect to the file server in long time, because the file server can not promptly inform the client when the file server has accomplished rebooting.

What is needed, therefore, is a system for automatically connecting the client computer to the server when the server has accomplished rebooting.

Similarly, what is also needed is a method for automatically connecting the client computer to the server when the server has accomplished rebooting.

### SUMMARY OF INVENTION

A system for automatically connecting a client computer to a server in accordance with a preferred embodiment includes at least a client computer, at least a server and a network. The client computer includes a request sending module, a time setting module, a time counting module and a connecting module. The request sending module is used for sending a request to the server in order to reboot the server. The time setting module is used for setting a wait time for the client computer before it is connected to the server, and displaying the wait time in the client computer. The time counting module is used for counting down the wait time, and determining whether the server has accomplished rebooting according to the wait time. The connecting module is used for connecting the client computer to the server when the server has accomplished rebooting.

Another preferred embodiment provides a method for automatically connecting a client computer to a server by utilizing the above system. The method includes the steps of: (a) sending a request to the server to reboot the server; (b) setting a wait time for the client computer; (c) displaying the wait time on the client computer; (d) counting down the wait time once each second; (e) determining whether the server has accomplished rebooting according to the wait time; and (f) connecting the client computer to the server automatically, if the server has accomplished rebooting.

Other advantages and novel features of the embodiments will be drawn from the following detailed description with reference to the attached drawings, in which:

### BRIEF DESCRIPTION OF DRAWINGS

FIG. 1 is a schematic diagram of an application environment of a system for automatically connecting a client computer to a server according to a preferred embodiment of the present invention;

FIG. 2 is a schematic diagram of function modules of the client computer of FIG. 1; and

FIG. 3 is a flowchart of a preferred method for automatically connecting a client computer to a server by implementing the system of FIG. 1.

### DETAILED DESCRIPTION

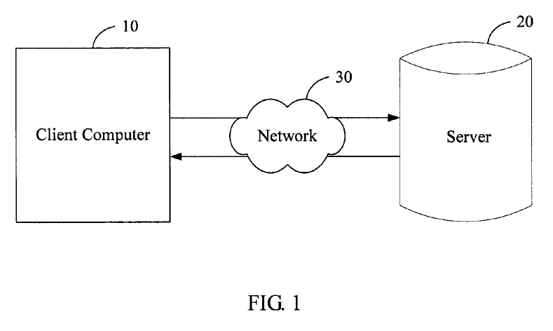

FIG. 1 is a schematic diagram of an application environment of a system for automatically connecting a client computer to a server (hereinafter “the system”) according to a preferred embodiment of the present invention. The system comprises at least one client computer 10, at least one server 20, and a network 30. The client computer 10 is connected with the server 20 via the network 30. The client computer 10 provides a browser interface which supports a hypertext transfer protocol (HTTP), a file transfer protocol (FTP), or an application named JavaScript. The client computer 10 has a plurality of function modules installed therein, for automatically connecting to the server 20. Users located at different places can manage the server 20 by means of utilizing the browser interface of the client computer 10 via the network 30. The server 20 may be a file server, an application server, or any other suitable HTTP server. The network 30 may be an intranet, the Internet, or any other suitable communication networks.

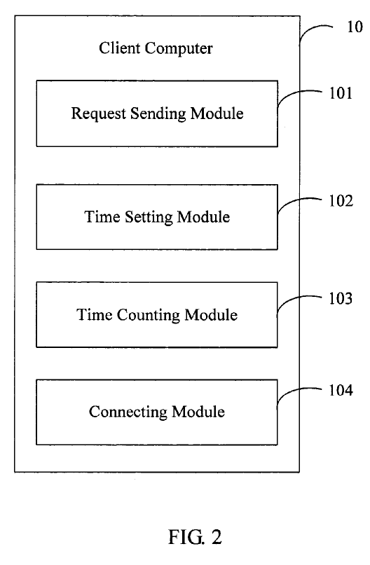

FIG. 2 is a schematic diagram of function modules of the client computer 10. The client computer 10 includes a request sending module 101, a time setting module 102, a time counting module 103, and a connecting module 104.

The request sending module 101 is used for sending a request to the server 20 by means of utilizing the browser interface of the client computer 10, in order to reboot the server 20. The time setting module 102 is used for setting a wait time for the client computer 10 before it is connected to the server 20. The wait time is displayed on the browser interface of the client computer 10, and is typically longer than a time of rebooting the server 20. The time counting module 103 is used for counting down the wait time, and for determining whether the server 20 has accomplished rebooting itself by means of determining whether the wait time equals 0. The connecting module 104 is used for connecting the client computer 10 to the server 20 when the server 20 has accomplished rebooting.

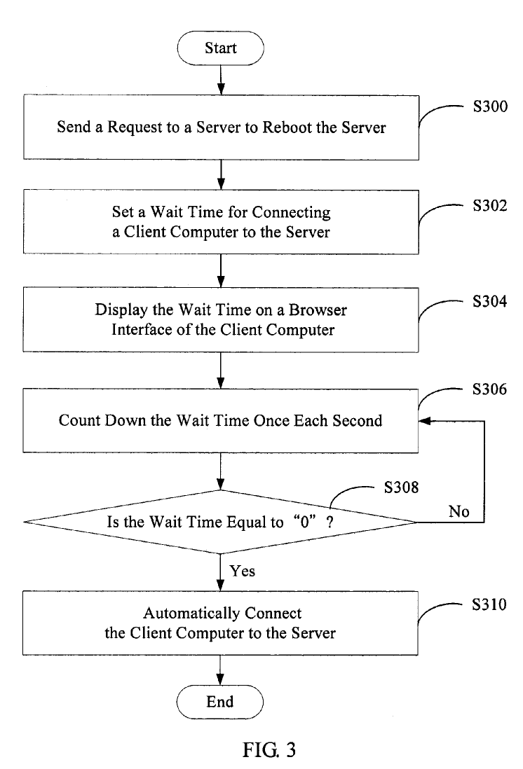

FIG. 3 is a flowchart of a preferred method for automatically connecting the client computer 10 to the server 20 by implementing the system of FIG. 1. In step S300, the request sending module 101 sends a request to the server 20, in order to reboot the server 20. In step S302, the time setting module 102 sets a wait time. The wait time is longer than a time of rebooting the server 20. In step S304, the time setting module 102 displays the wait time on the browser interface of the client computer 10. In step S306, the time counting module 103 counts down the wait time once each second. In step S308, the time counting module 103 determines whether the wait time is equal to 0 in order to determine whether the server has accomplished rebooting. If the wait time is not equal to 0, the procedure returns to step S306 described above. Otherwise, if the wait time is equal to 0, in step S310, the connecting module 104 automatically connects the client computer 10 to the server 20.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for automatically connecting a client computer to a server, the client computer comprising:
a request sending module for sending a request to the server in order to reboot the server;
a time setting module for setting a wait time for the client computer before it is connected to the server, and displaying the wait time on the client computer;
a time counting module for counting down the wait time, and determining whether the server has accomplished rebooting according to the wait time; and
a connecting module for connecting the client computer to the server when the server has accomplished rebooting.

2. The system according to claim 1, wherein the wait time is longer than a time of rebooting the server.

3. A method for automatically connecting a client computer to a server, the method comprising the steps of:
sending a request to the server to reboot the server;
setting a wait time for the client computer;
counting down the wait time once each second;
determining whether the server has accomplished rebooting according to the wait time; and
connecting the client computer to the server automatically, if the server has accomplished rebooting.

4. The method according to claim 3, further comprising the step of displaying the wait time on the client computer in real time.

5. The method according to claim 3, wherein the wait time is longer than a time of rebooting the server.

6. The method according to claim 3, wherein the step of determining whether the server has accomplished rebooting by means of determining whether the wait time is equal to “0”.
